(19) United States
(12) Patent Application Publication
(10) Pub. No.: US 2008/0084212 A1
(43) Pub. Date: Apr. 10, 2008

(54) Sensor For Locating Metallic Objects, And Measuring Device with Such a Sensor

(75) Inventor: Christoph Wieland, Herrenberg-Kuppingen (DE)

Correspondence Address: MICHAEL J. STRIKER, 103 EAST NECK ROAD, HUNTINGTON, NY, 11743, US

(73) Assignee: ROBERT BOSCH GMBH, Stuttgart (DE)

(21) Appl. No.: 11/576,925

(22) PCT Filed: Nov. 21, 2005
(86) PCT No.: PCT/EP05/56093

§ 371 Date: Apr. 9, 2007

(30) Foreign Application Priority Data
Jan. 18, 2005 (DE) 102005002238.3

(51) Int. Cl. G01V 3/10

(52) U.S. Cl. 324/329

(57) ABSTRACT

The invention relates to a sensor for locating metallic objects, especially an inductive metal sensor (110) for construction materials, said sensor comprising at least one emission coil (20) and at least one receiving conductor looping system (26) which are inductively coupled to each other. According to the invention, the at least one emission coil (20) is mounted in series with the primary side (30) of a compensation transformer (28). The invention also relates to a measuring instrument, especially a hand-held measuring instrument comprising one such sensor.

The present invention relates to a sensor for locating metallic objects as recited in the preamble to claim 1 and a measuring device with such a sensor as recited in claim 10.

### PRIOR ART

Current forms of sensors or detectors for locating metallic objects concealed in building materials, for example, generally function with inductive methods. They make use of the fact that both conductive and ferromagnetic materials influence the properties of an electromagnetic coil situated in the vicinity. Inductive locating devices usually function in accordance with the principle that one coil generates a magnetic coil and a second coil receives the magnetic field again, which has been modified by the presence of a metal object. A reception circuit of such a detector registers and evaluates the changes that metallic objects cause in the inductive properties. In this way, it is possible to basically locate metallic objects that are enclosed in a wall, for example, by means of one or more coils conveyed across the wall.

One technical challenge in the detection of metallic objects is that the feedback, which the objects to be located cause in the coil or coils of the sensor arrangement, is rather slight, comparatively speaking. This relates primarily to the influence of objects made of non-ferromagnetic materials such as copper, which is of great technical importance.

Even without external metallic objects in the vicinity of the coil arrangement of such a sensor, a powerful signal, the so-called dummy signal, can be measured in the reception coil of the sensor, which is due to the reciprocal inductive action of the coils of the sensor. In particular, this can lead to the fact that the inductive action of the coils on each other is significantly greater than the induction in the reception coil generated by an enclosed object.

Such a powerful offset makes it difficult to detect very slight inductive changes that are caused by a metallic object brought into the vicinity of the detector. The need to detect a very small change in the inductance in a very powerful offset signal requires the use of strictly toleranced and therefore expensive components and also requires very low-noise analog electronics that significantly increase the costs for such a locating device.

In order to counteract the offset problem in sensors of this kind, various approaches are known from the prior art, which all share the common goal of reducing the sensor signal that is present in the absence of metallic objects (dummy signal) and consequently increasing the relative signal changes due to the presence of an external object.

There are thus known locating devices that compensate for the dummy signal by means of a second reception coil; the second reception coil is connected to the first reception coil so that the dummy signals of the respective reception coils cancel each other out. The disadvantage of such a wiring is that an influence of an external object on the reception coils has virtually the same effect on both reception coils and thus the relative signals, in absolute terms, become even weaker. Moreover, an additional, second reception coil also involves additional costs.

DE 101 22 741 A1 has disclosed a detector for locating metallic objects, having a reception coil and a first transmission coil that are inductively coupled to each other. So that the weakest possible offset signal is produced in the detector, a second transmission coil is provided, which is likewise inductively coupled to the reception coil. The reception coil and the two transmission coils are arranged concentrically on a shared axis; the two transmission coils are dimensioned in terms of their numbers of turns and/or their physical dimensions so that the magnetic “dummy fluxes” that the two transmission coils excite in the reception coil cancel each other out.

The object of the invention is to disclose a detector of the type mentioned at the beginning, which is based on the detectors of the prior art and generates the weakest possible offset signal.

The object of the invention is attained by a sensor for locating metallic objects, having the defining characteristics of claim 1.

### ADVANTAGES OF THE INVENTION

The sensor for locating metallic objects according to the invention has at least one transmission coil and at least one reception coil loop system, which are inductively coupled to each other; the at least one transmission coil is connected in series with a compensation transformer. The compensation transformer whose primary side is connected in series with the transmission coil of the sensor generates a voltage that is ideally likewise phase-shifted by 90° in relation to the transmission current and proportional to it. If a transmission ratio is selected that is suitable for this compensation transformer, then with a suitable series of connection of the secondary winding of the transformer and the reception coil, the dummy signal of the sensor can be canceled out to 0. Since the compensation transformer remains uninfluenced by an external metal object, the output voltage of the transformer (compensation voltage) also remains constant and independent of interferences from an external metal object. As a result, the full influence that the metal object to be detected exerts on the reception voltage detectable in the reception coil of the sensor is retained and is likely not even partially compensated away by a corresponding voltage of a second reception coil that is used for compensation. The sensor according to the invention thus makes it possible to compensate for the dummy signal of such a sensor without requiring a second reception coil and transmission coil for compensation.

Advantageous modifications and embodiments of the sensor according to the invention are produced with the defining characteristics of the dependent claims.

An advantageous embodiment of the sensor according to the invention is achieved in that the numbers of turns of the primary and secondary side of the compensation transformer are selected in the same way as the numbers of turns of the at least one transmission coil and the at least one reception conductor loop system. This advantageous dimensioning of the number of turns of the transmission coil, reception conductor loop system, and compensation transformer results in the fact that the total voltage U_{G} that can be sensed in the system, which is calculated by adding the voltage U_{E} induced in the reception coil to the compensation voltage U_{K} present on the secondary side of the compensation transformer, ideally approaches zero in the absence of a metal object in the vicinity of the reception coil. Since a metal object in the vicinity of the reception coil changes the magnetic field induced in this coil, the presence of such an object also changes the voltage U_{E} induced in the reception coil. The compensation voltage U_{K} that can be sensed on the secondary side of the compensation transformer, however, remains unchanged. For this reason, an output voltage U_{G} (U_{G}=U_{E}+U_{K}) directly indicates the presence of a detected metal object in the vicinity of the reception coil.

The compensation transformer of the sensor according to the invention can be comprised of a small ferrite toroidal core and provided with two correspondingly dimensioned windings.

In the alternative embodiments of the sensor according to the invention, the compensation transformer can be partially or completely implemented in the form of a “printed transformer,” for example in that the primary and/or secondary coil of the transformer is/are applied, e.g. printed, directly onto a printed circuit board.

The compensation of the dummy signal of the sensor according to the invention (i.e. ^{U}E_{without} in the reception coil in the absence of an external metal object) can be implemented, for example, by means of a simple series circuit in which the secondary side of the compensation transformer is connected in series with the reception conductor loop system of the sensor. In this case, the windings of the secondary side of the compensation transformer are wound in the direction opposite from those in the reception conductor loop system.

In an alternative embodiment of the sensor according to the invention, a subtraction circuit can be provided, which subtracts the compensation voltage U_{K} of the compensation transformer from the voltage U_{E} that is induced in the reception conductor loop system from each other. In a subtractor of this kind, it is also possible, for example, for a fine tuning of the phase and magnitude of the compensation voltage U_{K} to occur.

The use of high frequencies is advantageous particularly for locating nonmagnetic materials since the penetration depth of the magnetic field into the object to be located decreases and the eddy currents induced in the object become more pronounced. But since the penetration depth in copper is already on the order of approximately 0.2 mm at a working frequency of 100 kHz, it is not generally constructive in practice to increase the working frequency much beyond 200 kHz for the sake of increasing the detection quality.

At least with the use of an inductive sensor for detecting metal in construction materials, this distance is already significantly less than the dimensions of relative objects such as power lines, water lines, or steel reinforcements. Sensors that should react to both conductive and ferromagnetic objects must therefore strike a compromise in the frequency choice of the system and suitably function in a frequency range between 1 kHz and 10 kHz. A frequency in the range from 4 to 6 kHz is particularly suitable since in this frequency window, ferrous objects and conductive objects of comparable sizes generate measurement signals of approximately the same amplitude.

With the sensor according to the invention, it is advantageously possible to produce a measuring device, in particular a hand-held locating device that has a significantly improved measuring sensitivity due to the fact that the dummy signal is largely compensated for.

Other advantages of the sensor according to the invention or of a measuring device equipped with the sensor according to the invention ensue from the drawings and the associated description.

### DRAWING

The drawings show an exemplary embodiment of a sensor according to the invention that will be explained in detail in the description below. The figures, the description, and the claims contain numerous defining characteristics in combination. Those skilled in the art will also consider these defining characteristics individually and unite them in other meaningful combinations.

FIG. 1 is a schematic depiction of the fundamental design of a sensor geometry of a sensor for locating metallic objects according to the prior art,

FIG. 2 is a simplified, schematic depiction of an exemplary embodiment of a sensor according to the invention, and

FIG. 3 shows an exemplary embodiment of a measuring device equipped with a sensor according to the invention.

### DESCRIPTION OF THE EXEMPLARY EMBODIMENT

As an introduction, the discussion below will first briefly touch on the principle known from the prior art of compensating for the offset in inductive sensors through the use of three concentric sensor coils.

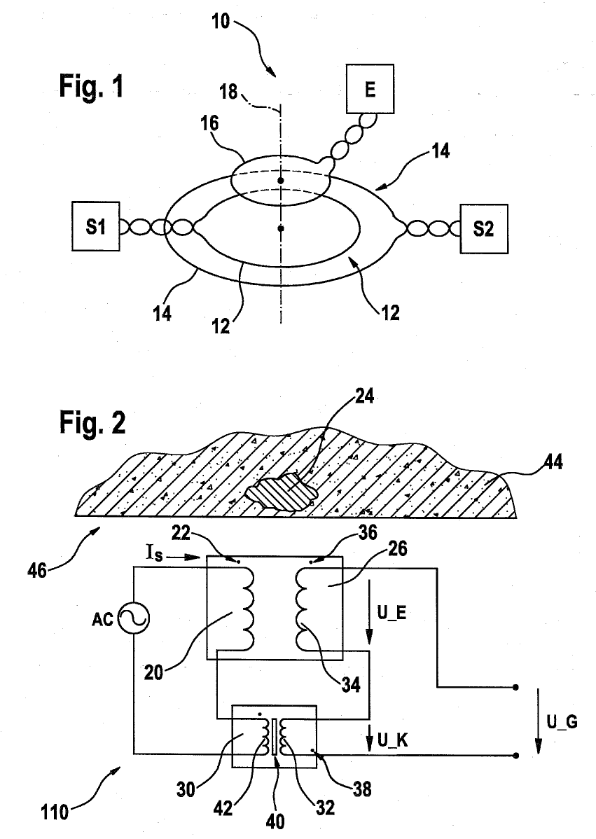

In order to illustrate the basic principle of a compensation sensor, FIG. 1 shows the fundamental design of a sensor or detector for locating metallic objects according to the prior art. The terms detector and sensor are used synonymously in this text. The sensor geometry 10 of a detector of this kind has three coils: a first transmission coil 12 that is connected to a first transmitter S1, a second coil 14 that is connected to a second transmitter S2, and a reception coil 16 that is connected to a receiver E. In the depiction shown in FIG. 1, each coil is represented as a circular line. The particularity of the arrangement of these three coils 12, 14, and 16 lies in the fact that they are all situated concentric to a common axis 18. The individual coils 12, 14, and 16 here have different outer dimensions so that the coil 12 can be inserted into the coil 14.

The two transmission coils 12 and 14 of the device according to FIG. 1 are supplied with alternating currents of opposing phase by their transmitters S1 and S2. The first transmission coil 12 induces a flux in the reception coil 16 that is oriented in opposition to the flux that the second transmission coil 14 induces in the reception coil 16. The two fluxes induced in the reception coil 16 reciprocally compensate for each other so that in the absence of any external metallic object in the vicinity of the coil arrangement 10, the receiver E does not detect any reception signal in the reception coil 16. The flux π that the individual transmission coils 12 and 14 excite in the reception coil 16 depends on various quantities such as the number of turns and the geometry of the coils 12 and 14 and, for example, on the amplitudes and reciprocal phase position of the currents supplied to the two transmission coils 12 and 14.

In the detectors of the prior art, these quantities must in the end be optimized so that in the absence of a metallic object, no flux or as little flux π as possible is excited in the reception coil 16 when current flows through the transmission coils 12 and 14. In the coil arrangement 10 according to FIG. 1, the first transmission coil 12 that is connected to the first transmitter S1 and a second transmission coil 14 that is connected to a second transmitter S2 are situated coaxial to each other in a common plane. The reception coil 16 is situated in a plane offset from that of the two transmission coils 12 and 14.

FIG. 2 schematically depicts an exemplary embodiment for the connection of the transmission and reception coils of a sensor according to the invention and the associated compensation circuit that is implemented with the aid of a compensation transformer.

The sensor 110 according to the invention has a transmission coil 20 with a plurality of windings that are indicated only schematically in the depiction according to FIG. 2. The transmission coil can be a classically wound coil or can also be a corresponding conductor strip structure on a printed circuit board. The transmission coil 20 is supplied with an alternating current Iₛ and generates a variable magnetic field in the frequency range of less than 1 MHz. Preferably, magnetic fields in a frequency range from 100 Hz to 200 kHz are used in the sensor according to the invention. The dot 22 in the depiction in FIG. 2 corresponds to the winding connections and thus indicates the winding direction of the transmission coil 20. The magnetic field of the transmission coil 20 is modified by an object, in particular a metallic object 24, situated in the vicinity of the coil and generates a corresponding induction current in the reception conductor loop system 26 serving as a reception coil, which is also depicted only schematically in FIG. 2. The change in the magnetic field of the transmission coil 20 due to the presence of the metal object 24 can be detected by means of a corresponding evaluation circuit of the reception coil 26, e.g. through measurement of the induced voltage U_{E}.

But even in the absence of a metal object 24 in the vicinity of the coils 20 and 26, a relatively powerful signal (“dummy signal”) is produced, which can be sensed and measured in the reception coil. Metal objects change the reception signal, e.g. U_{E}. The dummy signal ^{U}E_{without} in the reception coil 26 is proportional to the current Iₛ in the transmission coil and ideally, is phase-shifted by 90° in relation to it.

According to the invention, a special compensation transformer 28 is provided, whose primary side 30 is connected in series with the transmission coil 20. A compensation transformer of this kind generates a voltage U_{K} that is likewise ideally phase-shifted by 90° and is proportional to the transmission current Iₛ. If a suitable transmission ratio between the number of turns on the primary side 30 and secondary side 32 of the compensation transformer is selected, then by suitably connecting the secondary side windings of the transformer in series with the windings of the reception coil 26, it is possible to cancel out the resulting dummy signal.

To that end, in the exemplary embodiment in FIG. 2, the secondary side 32 of the compensation transformer 28 is connected in series with the windings 34 of the reception coil 26. The compensation of the dummy signal (^{U}E_{without}) is thus implemented by means of a series circuit in which the winding direction is reversed between the windings 34 of the reception coil 26 and the windings 32 of the compensation transformer 28. This is symbolized in the depiction in FIG. 2 by the dots of the winding connections 36 for the reception coil and 38 for the secondary windings of the compensation transformer 28.

Through suitable dimensioning of the numbers of turns of the transmission coil 22, reception coil 26, and compensation transformer 28, the voltage U_{G} that can be sensed by the sensor according to the invention is (U_{G}=U_{E}+U_{K}) in the ideal case and approaches zero in the absence of a metal object in the vicinity of the reception coil 26. Since a metal object changes the field induced in the reception coil 26, in the absence of such a metal object 24, the voltage U_{E} induced in the reception coil 26 also changes. The compensation voltage U_{K} on the secondary side 32 of the compensation transformer, however, remains unchanged with an appropriately shielded compensation capacitor. As a result, the voltage U_{G} that can be detected in the sensor according to the invention indicates that a metal object 24 has been found.

A suitable transmission ratio of the primary and secondary windings of the compensation transformer is, in a first approximation, identical to the transmission ratio of the windings of the transmission coil in relation to the reception coil. Since the compensation transformer 28 is situated in the sensor 110 or an associated measuring device in such a way that it remains uninfluenced by metal objects, the output voltage U_{K} of the transformer 28 also remains independent of the interference caused by the metal object 24 and is therefore constant. As a result, the full influence of the metal object 24 on the reception voltage U_{E} is retained and is not also compensated away as is customary in sensors according to the prior art.

For example, the compensation transformer can be comprised of a ferrite toroidal core 40 and be provided with two correspondingly dimensioned windings 32 and 42. However, it is also possible to implement the compensation transformer in the form of a printed transformer in that the primary and secondary coils of such a transformer are applied, e.g. printed, directly onto a printed circuit board.

In addition to the sensor system schematically depicted in FIG. 2, a measuring device according to the invention also has, among other things, an evaluation circuit as well as an evaluation and computing unit that ascertains information about the presence of a metallic object 24 based on the corresponding measurement signals such as U_{E}, U_{K}, or U_{G}. Information of this kind is then transmitted to an output unit, e.g. in acoustic or optical output unit, of an associated measuring device so that an appropriate signal alerts the user that an object has been located. The precise identification of the location of such an object, which can be enclosed, for example, within a wall 44 that is only indicated in FIG. 2, can occur, for example, through the output of the signal strength of the magnetic field interference caused by the enclosed object or through the signal strength of a current induced by this magnetic field.

The sensor according to the invention, together with the control and evaluation unit and a corresponding output unit, is integrated into a housing of a measuring device, in particular a compact hand-held measuring device. Such a measuring device can be manually moved with its housing or also by means of rollers situated on the housing over the surface of a wall, floor, or ceiling to be inspected.

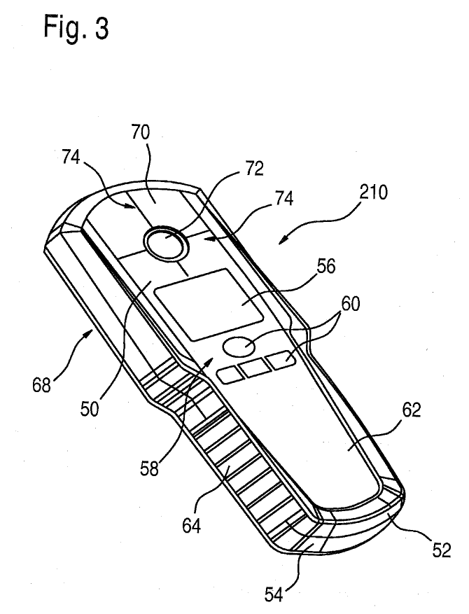

FIG. 3 shows a possible exemplary embodiment of a measuring device of this kind.

FIG. 3 shows a perspective overall representation of an exemplary embodiment of a measuring device according to the invention. The measuring device has a housing 50 that is comprised of an upper half shell 52 and a lower half shell 54. Inside the housing, at least one sensor according to FIG. 2 is provided with a coil arrangement for metal detection. In addition, the inside of the measuring device is equipped with signal generation- and evaluation electronics as well as a power supply, e.g. batteries or a rechargeable battery pack. The measuring device according to FIG. 3 also has a display 56 for issuing an output signal that correlates to the measurement signal. The display 56, e.g. a segmented bar display or a graphic display through the use of an LCD, makes it possible to represent the strength of the detected measurement signal.

The measuring device according to the invention also has a control area 58 with a number of control elements 60 that make it possible, for example, to switch the device on and off and to start a measuring procedure or calibration procedure as needed.

In the region below the control area 58, the measuring device according to FIG. 3 has a region 62, which, in its shape and materials, is embodied as a handle 64 for guiding the measuring device according to the invention. By means of this handle 64, the measuring device is guided with its underside oriented away from the observer in FIG. 3 along a surface of a component or medium to be inspected, e.g. the surface 46 of a wall 44 according to the schematic depiction in FIG. 2.

At its end 70 oriented away from the handle 64, the measuring device has an opening 72 passing through the housing. The opening 72 is situated concentrically in relation to at least the reception conductor loop system 34 of the sensor. In this way, the location of the opening 72 in the measuring device corresponds to the center of the locating sensor, thus also simultaneously showing the user of such a device the precise location of a potentially detected object. In addition, the measuring device also has marking lines 74 on its top side, which allow the user to locate the precise center of the opening 72 and thus the position of the enclosed object.

In addition to a purely inductive measuring device, the sensor according to the invention can also be used as an auxiliary sensor in measuring units that use other measuring methods. It is thus possible, for example, to also use the compensated, inductive sensor as an auxiliary diagnostic device in a radar locating device or an infrared locating device.

The sensor according to the invention and the measuring device according to the invention that is equipped with such device are not limited to the exemplary embodiments shown in the drawings.

In particular, the sensor according to the invention is not limited to the use of only one transmission coil and one reception conductor loop system. It can also be used in multiple systems, possibly through the use of a plurality of compensation transformers.

What is claimed is:

1. A sensor for locating metallic objects, in particular an inductive metal sensor (110) for building materials, having at least one transmission coil (20) and at least one reception conductor loop system (26) that are inductively coupled to each other,
wherein the at least one transmission coil (20) is connected in series with the primary side (30) of a compensation transformer (28).

2. The sensor as recited in claim 1,
wherein the numbers of turns of the primary side (30) and secondary side (32) of the compensation transformer (28) have the same ratio to each other as the numbers of turns of the transmission coil (20) and the reception conductor loop system (26).

3. The sensor as recited in claim 1,
wherein the compensation transformer (28) has a ferrite toroidal core (40).

4. The sensor as recited in claim 1,
wherein at least one winding system of the windings of the compensation transformer (28) is embodied in the form of a printed conductor strip structure on a printed circuit board.

5. The sensor as recited in claim 1,
wherein the compensation transformer (28) is embodied in the form of a printed transformer on a printed circuit board.

6. The sensor as recited in claim 1,
wherein the secondary side (32) of the compensation transformer (28) is connected in series with the reception conductor loop system (26).

7. The sensor as recited in claim 6,
wherein the secondary side (32) of the compensation transformer (28) is wound in the opposite direction from the winding direction of the reception conductor loop system (26).

8. The sensor as recited in claim 1,
wherein a subtraction circuit is provided, which subtracts the voltage U_{E} that is induced in the reception conductor loop system (26) and the voltage U_{K} that is detectable on the secondary side of the compensation transformer (28) from each other.

9. The sensor as recited in claim 1,
wherein magnetic fields in the frequency range of less than 1 MHz, preferably magnetic fields in the frequency range from 100 Hz to 200 kHz, are used.

10. A measuring device, in particular a hand-held locating device 210, having at least one sensor as recited in claim 1.
